(19) United States
(12) Patent Application Publication
(10) Pub. No.: US 2007/0085926 A1
(43) Pub. Date: Apr. 19, 2007

(54) LIGHT EMITTING DEVICE, CAMERA WITH LIGHT EMITTING DEVICE, AND IMAGE PICKUP METHOD

(75) Inventors: Masami Yuyama, Tokyo (JP); Kaoru Yoshida, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Ltd., Tokyo (JP)

(21) Appl. No.: 11/613,423

(22) Filed: Dec. 20, 2006

Related U.S. Application Data
(62) Division of application No. 10/155,361, filed on May 24, 2002.

(30) Foreign Application Priority Data
May 31, 2001 (JP) 2001-163934
Aug. 28, 2001 (JP) 2001-257660

(51) Int. Cl. H04N 5/222

(52) U.S. Cl. 348/370

(57) ABSTRACT

A camera comprises a lens and an LED array at its front. The LED array is composed of red, green and blue LEDs, which are individually turned on and off for light emitting purposes, as well as changeable in their quantities of red, green and blue lights to be emitted under control of an MPU. Thus, the LED array is capable of emitting light having any color having a different brightness by controlling the respective quantities of red, green and blue lights to be emitted by the corresponding LEDs. That is, the camera is capable of irradiating an object with light having a desired color for image pickup.

### CROSS-REFERENCE TO RELATED APPLICATIONS

The present application is a Divisional Application of U.S. application Ser. No. 10/1557361, filed May 24, 2002.

The present invention relates to cameras, flash devices and cameras with flash devices.

Recently, digital cameras that pick up an image of an object, using a CCD type or MOS type solid state image pickup device, and that record corresponding image data on a recording medium such as a flash memory have generally diffused. Many digital cameras each have a strobe device similar to that of a conventional camera.

The conventional general strobe device emits an auxiliary image-pickup light as follows. A microcomputer controls a set-up transformer to increase a voltage from a power supply to about 320 volts, which then charge a main capacitor and maintains its charged state. In image pickup, the microcomputer causes a driver to drive a trigger coil, which then applies a voltage of not less than 200 volts to a discharge tube. This causes the discharge tube to irradiate an object with light. An optical sensor senses reflected light from the object. When a quantity of the reflected light reaches a prescribed one, a sensor circuit stops light emission to thereby ensure an appropriate auxiliary light.

In order to obtain an auxiliary image-pickup light in the conventional strobe device, the set-up transformer, main capacitor and trigger coil for obtaining appropriate power to be supplied to the strobe device are indispensable, in addition to the discharge tube. Therefore, the strobe device is made of many parts, consumes much power, and will generate noise when high voltage is generated. Thus, in order to incorporate the strobe device into the camera it is necessary to protect the other circuits of the camera from noise.

In the conventional strobe device, electric charges must be stored in a capacitor and then discharged for causing the discharge tube to emit light. Therefore, continuous light emission is limited.

### SUMMARY OF THE INVENTION

According to one aspect of the present invention, there is provided a camera apparatus with a flash device, comprising:

a pickup device for picking up an image of an object;

a plurality of light emitting elements each for emitting a different colored light;

a driver for supplying power to a respective one of the plurality of light emitting elements;

a controller for controlling the supplying of the power by the driver to a respective one of the plurality of light emitting elements such that the plurality of light emitting elements each emit a light having a different color at a required timing of light emission; and

a storage device for storing as image data the image of the object picked up by the pickup device.

According to another aspect of the present invention, there is provided a flash device, comprising:

a plurality of light emitting elements each for emitting light having a different-color;

a driver for supplying power to the plurality of light emitting elements; and

a controller for controlling the supplying of the power by the driver to the plurality of light emitting elements such that the plurality of light emitting elements each emit a different colored light at a required timing of light emission.

According to still another aspect of the present invention, there is provided a camera apparatus with a flash device, comprising:

an image pickup device for picking up an image of an object;

a storage device for storing as image data an image of the object picked up by the image pickup device;

a light emitting device of a plurality of light emitting diodes disposed on a camera body for emitting a like number of different-colored lights, and for irradiating the object with the like number of different-colored lights;

a driver for supplying power to a respective one of the plurality of light emitting diodes;

a setting device for setting a quantity of light to be emitted by at least one of the plurality of light emitting diodes; and

a controller for controlling the driver such that the at least one of the plurality of light emitting diodes emits a corresponding light in the set quantity of light set by the setting device when the image of the object is picked up.

According to a further aspect of the present invention, there is provided a method of controlling a camera apparatus with a plurality of light emitting diodes disposed on a camera body, each light emitting diode emitting a different-colored light, the method comprising the steps of:

picking up an image of an object for confirming purposes, using an image pickup device;

setting data on a quantity of light to be emitted by at least one of the plurality of light emitting diodes, based on the image of the object picked up by the image pickup device;

controlling a quantify of light to be emitted by the at least one of the plurality of light emitting diodes in the image pickup in accordance with the data on the quantity of light set in the setting step in synchronism with the image of the object for recording purposes being picked up by the image pickup device in response to a shutter button being operated; and

recording in a recording device data on the image picked up by the image pickup device in response to the shutter button being operated.

### BRIEF DESCRIPTION OF THE DRAWINGS

The objects and advantages of the present invention will become more apparent from the following detailed description of the presently preferred examplary embodiments of the invention taken in conjunction with the accompanying drawings, in which:

FIG. 1 is a block diagram of a flash device as a first embodiment of the present invention.

FIG. 2 is a flowchart of a process for setting a brightness in the first embodiment.

FIG. 3 is a timing chart of operation of the first embodiment.

FIG. 4 illustrates a relationship between drive current necessary for driving an associated LED and color of light to be emitted in the first embodiment.

FIG. 5 is a timing chart of operation of a second embodiment.

FIG. 6 is a block diagram of an electronic still camera as a third embodiment.

FIG. 7 is a timing chart of operation of the still camera of the third embodiment for autofocus control.

FIG. 8 is a timing chart of operation of the still camera of the third embodiment for autoexposure control.

FIG. 9 is a timing chart of operation of the still camera of the third embodiment for auto white-balance control.

FIG. 10 is a timing chart of operation of the still camera of the third embodiment for red-eye prevention control.

FIG. 11 is a timing chart of operation of the still camera of the third embodiment for movie image pickup.

FIG. 12 is a timing chart of operation of the still camera of the third embodiment for multi-image pickup.

FIG. 13 is a timing chart of operation of the still camera of the third embodiment for self-timer image pickup.

FIG. 14 is a front view of an electronic still camera of a fourth embodiment.

FIG. 15 is a plan view of the still camera of the fourth embodiment.

FIG. 16 is a back view of the still camera of the fourth embodiment.

FIG. 17 is a block diagram of the camera of the fourth embodiment.

FIGS. 18A through 18E illustrate transitions of display pictures in the electronic camera of the fourth embodiment.

FIG. 19 is a general flowchart of a process to be performed by the camera of the fourth embodiment.

FIG. 20 is a flowchart of a manual mode process of the camera of the fourth embodiment.

FIG. 21 is a flowchart of an image-pickup scene corresponding mode process of the camera of the fourth embodiment.

FIG. 22 is a flowchart of a pickup-image corresponding mode process of the camera of the fourth embodiment.

FIG. 23 is a flowchart of a preliminary image-pickup mode process of the camera of the fourth embodiment.

### DESCRIPTION OF THE PREFERRED EMBODIMENTS

### First Embodiment

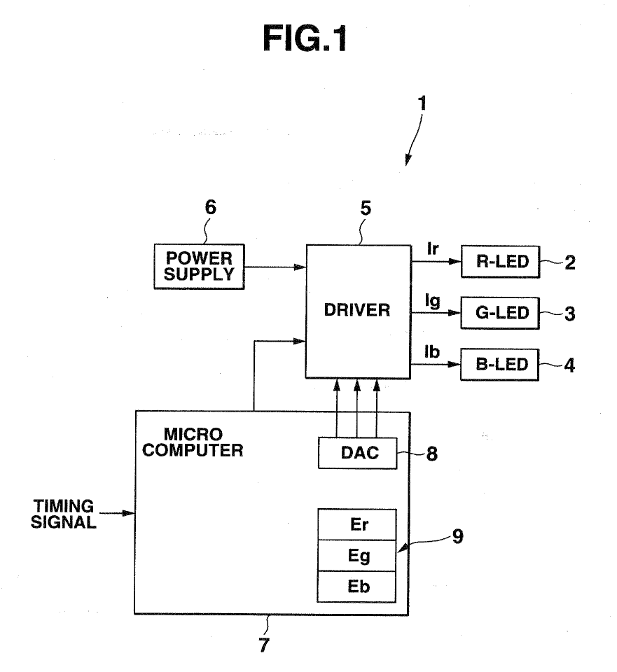

FIG. 1 is a block diagram of an electrical structure of a flash device 1 according to the present invention. The flash device 1 comprises red, green and blue light emitting elements, for example, light emitting diodes LEDs (R-LED-R, G-LED, B-LED) 2, 3 and 4 that emit red, green and blue lights, respectively, a driver 5 that drives the LEDs 2,3 and 4, a power supply 6 such as a battery, and a microcomputer 7. The red, green and blue LEDs 2, 3 and 4 each may be single or plural. The microcomputer 7 comprises a DAC 8 that converts a digital signal to an analog signal, and a brightness set memory 9 in which data on set voltages Er, Eg and Eb for the red, green and blue LEDs 2, 3 and 4, respectively, are stored. The data on the set voltages Er, Eg and Eb are brightness set information to determine a hue of light to be emitted by the flash device 1, and are set in the factory concerned.

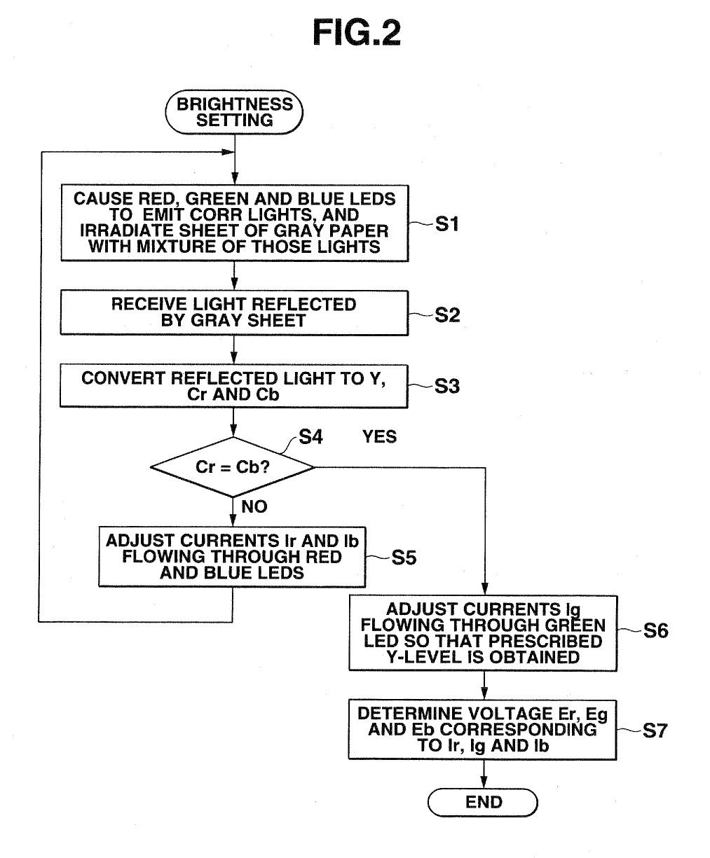

FIG. 2 illustrates a process for brightness setting for the respective LEDs to be performed in the factory In the brightness setting, first, the LEDs 2-4 are caused to emit their respective red, green and blue lights, which are then mixed. A sheet of gray paper is then irradiated with the mixed lights. A CCD (not shown) receives the light reflected by the sheet of paper and then converts the reflected light to a brightness signal Y, and color difference signals Cr and Cb (step S1-S3). Drive currents Ir and Ib that flow through the red and blue LEDs 2 and 4, respectively, are adjusted so that Cr=Cb (steps S4, S5). Thereafter (YES in step S4), a current Ig flowing through the green LED 3 is adjusted so that a prescribed Y level is obtained. At this time, Ir and Ib are re-set so that Ir/Ig and Ib/Ig maintain the relationship Cr=Cb (step S6) to thereby determine the values of Ir, Ig and Ib that provide respective brightnesses of the LEDs at which the mixed lights become a synthetic white light. Then, voltages Er, Eg and Eb corresponding to the Ir, Ig and Ib are obtained as set voltages (step S7). In the brightness setting, the CCD used to receive the reflected light from the sheet of gray paper should have a color resolution higher than a predetermined one. When the flash device 1 is incorporated into an electronic still camera, the CCD built in the still camera is used as such.

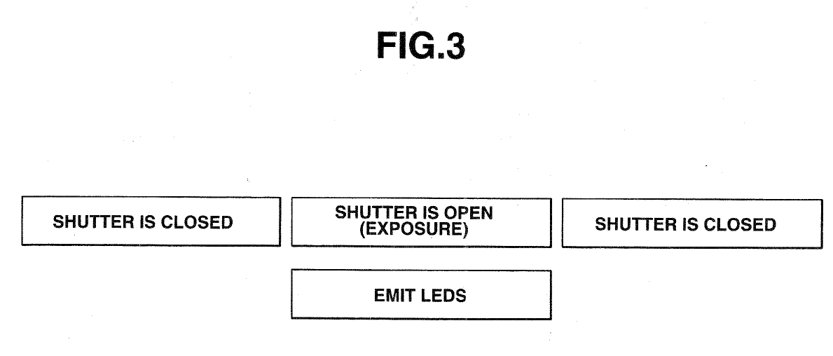

The microcomputer 7 functions as control means of the flash device in accordance with programs stored therein. The microcomputer 7 responds to a timing signal from a camera (not shown) to deliver an on/off signal to the driver 5 at a shutter opening/closing timing, for example, as shown in FIG. 3, and causes the driver 5 to flow drive currents through the red, green and blue LEDs 2, 3 and 4 to thereby emit corresponding colored lights. In this case, the DAC 8 applies to the driver 5 respective color DC voltages corresponding to the voltage data stored in the brightness set memory 9 to thereby set the drive currents Ir, Ig and Ib flowing through the LEDs 2-4 to respective predetermined values. Thus, the red, green and blue LEDs 2, 3 and 4 emit their respective colored lights at different brightnesses to thereby provide a synthetic white light of their mixed lights.

In the above arrangement, the respective LEDs 2-4 require small power to emit corresponding red, green and blue lights, and the driver 5 is made of a small number of simple parts. Thus, the flash device 1 is composed of a small number of parts, has a small size and reduces power consumption, compared to the conventional ones. When the flash device 1 is incorporated into a camera, no measures to cope with noise need be taken.

In the present embodiment, the respective LEDs 2-4 are set to provide their respective predetermined brightnesses in light emission to thereby provide a white light (as an auxiliary image-pickup light) appropriate for the flash device 1 and hence the camera device that incorporates the flash device 1.

While in the embodiment the LEDs 2-4 that emit three different colors are illustrated as being used, a single white LED capable of emitting a white light may instead be used to thereby allow the microcomputer 7 to turn on/off the LED simply. Also in that case, the flash device 1 is composed of a small number of parts, has a small size and reduces power consumption, compared to the conventional ones. Even when the flash device is incorporated into a camera device, no measures to cope with noise need be taken.

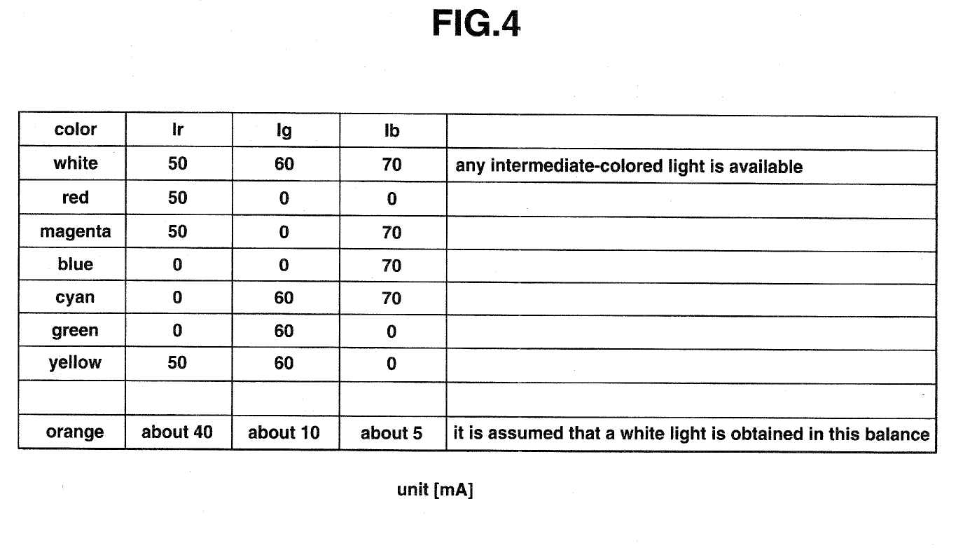

While in the embodiment the brightness set memory 9 has been illustrated as having stored data on the set voltages Er, Eg and Eb to provide a white light finally, the brightness set memory 9 may beforehand store brightness set information to provide rays of light having colors different from white. For example as shown in FIG. 4, the brightness set memory 9 can beforehand store data on set voltages corresponding to 50, 60 and 70 mA as the driving currents Ir, Ig and Ib for the three LEDs 2-4, respectively, in order to provide a white light; data on set voltages corresponding to 50, 0 and 0 mA as the driving currents Ir, Ig and Ib, respectively, in order to provide a red light; data on set voltages corresponding to 40, 10 and 5 mA as the driving currents Ir, Ig and Ib, respectively, in order to provide an orange light; and so forth. The last example illustrates that light having an intermediate color different from the original colors of light to be emitted by the respective red, green and blue LEDs is available by setting appropriately the respective voltages to be applied to the corresponding LEDs. That is, a plurality of items of brightness setting information (on three groups of set voltages, each group being directed to a respective one of Er, Eg and Eb) may be beforehand stored in the brightness set memory 9 so that two or three set voltages each selected from a respective one of the three groups may be applied to the corresponding LEDs to thereby emit an intermediate-colored light.

### Second Embodiment

A second embodiment of the present invention will be described next. This embodiment is a flash device 1 having the same structure as that of FIG. 1 except that the microcomputer 7 contains programs different from those that the microcomputer 7 of the first embodiment does.

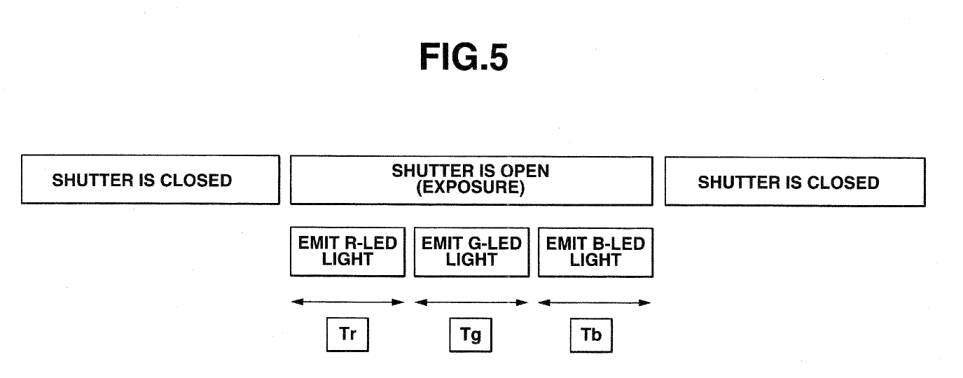

FIG. 5 illustrates the contents of control provided by the microcomputer 7 in this embodiment. The microcomputer 7 responds to a timing signal from a camera (not shown) to cause red, green and blue LEDs 2, 3 and 4 to sequentially emit corresponding colored lights for time periods Tr, Tg and Tb, respectively in a time divisional manner so that Tr:Tg:Tb=Ir:Ig:Ib, or the ratio of Tr, Tg and Tb correspond to the ratio of Ir, Ig and Ib, respectively.

This embodiment produces advantageous effects similar to those provided by the first embodiment because a white light is available. In addition, the driving current consumed for the same time period is one third of that consumed in the first embodiment. Thus, a burden to be imposed on the power supply 6 to obtain a white light, using the LEDs 2-4 that emit different-colored lights is reduced. Thus, the power supply 6 may be a battery having a reduced capacity compared to the first embodiment.

The respective emission times of the respective LEDs 2-4 are calculated by the microcomputer 7 based on the ratio of the driving currents Ir, Ig and Ib, and the determined emission time (for example, including an exposure time period (FIG. 5) indicated by a specific signal supplied along with a timing signal from the camera, and a different time period set separately in the flash device 1) each time the light emission concerned should occur. The ratio of the driving currents Ir, Ig and Ib to be used for the calculation may be either calculated from data on the driving currents Ir, Ig and Ib stored in the brightness set memory 9 each time the light emission should occur or may be stored as data separately in the brightness set memory 9 when the driving currents Ir, Ig and Ib were stored.

The ratio of the emission times of the respective LEDs 2-4 can be that of the driving currents Ir, Ig and Ib that provides light having a color different from white (as described with reference to FIG. 4). Thus, time-divisional control of emission times of the respective LEDs 2-4 provides light having a respective one of different colors as required.

### Third Embodiment

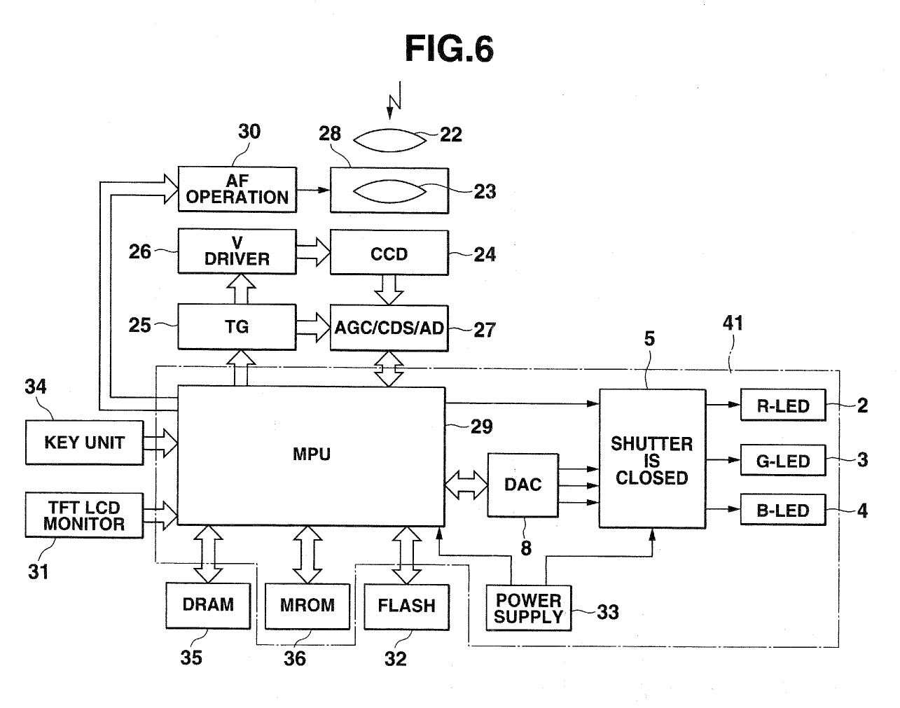

Next, a third embodiment will be described with respect to FIG. 6 that is a block diagram of an electrical structure of an electronic still camera 21 comprising a flash device according to the present invention. The still camera 21 comprises a fixed lens 22, a focus lens 23, a CCD 24 as image pickup means that picks up an image of an object focused through the focus lens 23, a TG (timing generator) 25 that drives the CCD 24, a V-(vertical) driver 26, a composite circuit 27 that comprises a CDS (Correlated Double Sampling) circuit that performs a correlated double sampling operation on an image signal from the CCD 24 and holds resulting data, an automatic gain control amplifier (AGC) that amplifies the image signal in an automatically gain-controlling manner, and an A/D converter (AD) that converts the amplified image signal to a digital signal. The focus lens 23 is held by a driving mechanism 28 that includes an AF (autofocus) motor. For focus control, the focus lens 23 is moved axially through the driving mechanism 28 and the AF driver 30 by a controller MPU 29 that controls the whole camera 21. The charge storage time of the CCD 24 is changed by the TG 25, which responds to a shutter pulse output from the MPU 29, and the V driver 26 to thereby cause the CCD 24 to function as an electronic shutter.

The MPU 29 has various signal and image processing functions. It produces a video signal based on the digital image signal from the composite circuit 27 and displays on a TFT liquid crystal monitor 39 as a monitor image an image of an object picked up by the CCD 24. In image pickup, the MPU 29 compresses the picked-up image signal into an image file having a predetermined format, and then stores it in a flash memory 32 whereas in reproduction, the MPU 29 expands the compressed image file and displays a resulting image on the monitor 31.

The MPU 29 is connected to a power supply 33 that, for example, includes a battery, a key unit 34 of various keys including a shutter key, a DRAM 35 functioning as a work memory, a ROM 36 that has stored various operating programs necessary for data processing and control of the respective elements of the camera, a DAC 8, and a driver 5. The DAC 8 and the driver 5 are similar to those of each of the first and second embodiments. The driver 5 is connected to red, green and blue LEDs 2, 3 and 4.

The ROM 36 has stored data on set voltages Er, Eg and Eb similar to those described in the first embodiment and necessary for control of the respective brightnesses of the red, green and blue LEDs 2, 3 and 4, and programs necessary for operating the microcomputer 7 in the same manner as in each of the first and second embodiments. Thus, the inventive flash device 41 is comprised of the MPU 29, ROM 36, power supply 33, DAC 8, driver 5, and the respective LEDs 2-4. The ROM 36 has stored programs that cause the MPU 29 to function as focusing means, exposure control means and white balancing means.

Various operations of the flash device 41 of the camera 21 under control of the MPU 29 will be described next:

AF Operation:

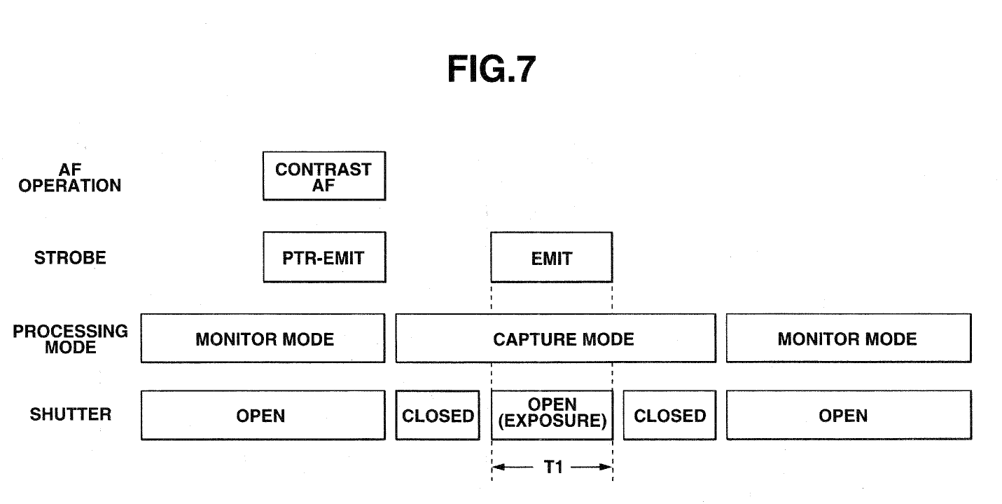

FIG. 7 is a timing chart indicating operation of the camera 21 in auto-focus (AF) control by the MPU 29. The focus control in this embodiment is a contrast AF that integrates a quantity of high frequency components contained in an image signal output from the CCD 24, for example, for one field period, and moves the focus lens 23 along the optical axis so that the integrated value, which is handled as an AF evaluated value, becomes maximum.

When the monitor mode has been set by the user in this operation, the camera 21 causes the CCD 24 to start to acquire the image (opens its shutter), and displays the acquired (monitor) image on the monitor 31. During this operation, the MPU 29 causes the respective LEDs 2-4 to pre-emit their respective lights while performing the contrast AF control. When the user presses the shutter key during this operation, control passes to a capture mode. In this mode, the acquisition of the image by the CCD 24 is temporarily stopped (the shutter is closed). Then, the MPU 29 supplies the respective predetermined currents (for example, driving currents Ir, Ig and Ib described in the first embodiment) to the corresponding LEDs 2-4 (strobe) for the predetermined exposure time T to emit their respective lights regularly while causing the CCD 24 to acquire the image (the shutter is open; exposure). After a lapse of the exposure time, the MPU 29 causes the CCD 24 to temporarily stop the acquisition of the image (the shutter is closed). The monitor mode is then resumed to reopen the acquisition of the image.

In the above operation, during the contrast AF in the monitor mode the LEDs 2-4 are caused to pre-emit their respective lights to thereby compensate for insufficient information from the CCD 24 to perform the AF control satisfactorily in the image pickup in a dark place to thereby achieve an accurate focusing operation. The brightnesses that the respective LEDs 2-4 should ensure in pre-emission are sufficient so long as the contrast AF is achieved, and need not be so high as those of the LEDs 2-4 required when the LEDs 2-4 emit their respective lights regularly. Thus, power consumption required for the pre-emission is small and the battery life is not greatly affected even when the AF control is performed for a relatively long time. That is, the battery life is maintained while the range of use of the contrast AF is extended.

The opening/closing operation of the shutter is unnecessary when a progressive CCD is used which performs a left-to-right horizontal scan and an up-to-down vertical scan sequentially for an image when the image is read (sequentially image-reading system).

AE Operation:

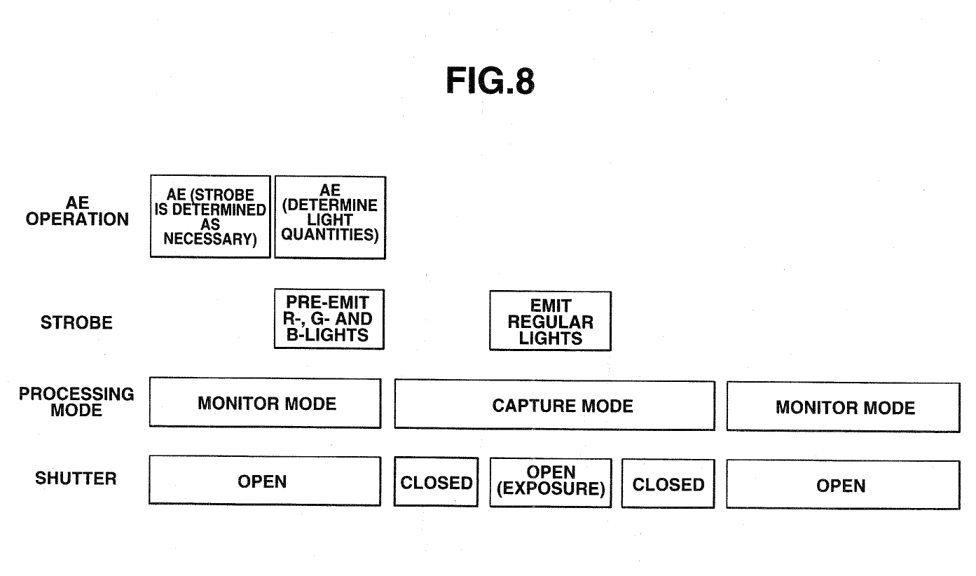

FIG. 8 is a timing chart of operation of the camera 21 for auto exposure (AE) control by the MPU 29. In this operation, when the user sets a monitor mode, the MPU 29 immediately pre-senses a degree of exposure under AE control. When the MPU 29 determines that the exposure is insufficient and that a strobe is needed, it drives the LEDs 2-4 to pre-emit their respective lights to thereby calculate their respective quantities of light emissions (brightnesses and emission times) necessary for their regular emissions during the AE operation for the image pickup immediately before passing to a capture mode. Then, when the capture mode is set, the MPU 29 causes the respective LEDs 2-4 to emit the respective lights in the corresponding calculated brightnesses and emission times and to cause the CCD to acquire the image. Then, the capture mode is resumed. The opening/closing operations of the shutter in the respective processing modes (including the monitor and capture modes) are similar to the corresponding operations performed in the autofocus control of FIG. 7.

In the above operation, even when an image is picked up in a dark place, a degree of exposure in the image pickup is accurately sensed. Even in such case, the brightnesses that the respective LEDs 2-4 should ensure in the pre-emission of their lights should be at most as high as the AE operation is possible, and need not be the same as in the regular emission. The power consumption required for the pre-emission is very small. Thus, the battery life is maintained while accurate exposure control is achieved even in a dark place.

AWB Operation:

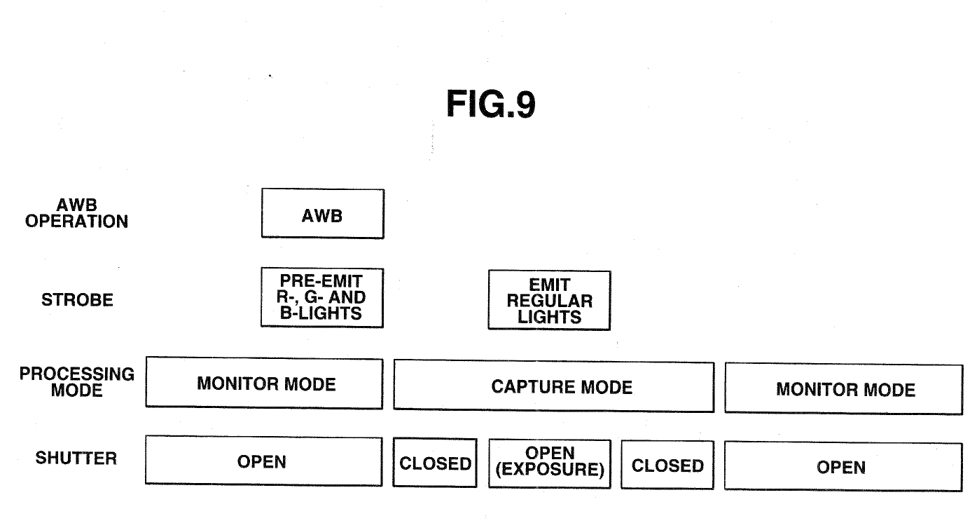

FIG. 9 is a timing chart of operation of the camera 21 for auto white-balance (AWB) control by the MPU 29. In such operation, after the user sets the monitor mode the MPU 29 causes the respective LEDs 2-4 to pre-emit their respective lights immediately before passing to the capture mode. In this state the MPU 29 performs the AWB operation in which white is detected based on an image signal output from the CCD 24 in the image pickup, and sets gains for the respective color components in the automatic gain control amplifier of the composite circuit 27. Then, when the control passes to the capture mode, the MPU 29 causes the respective LEDs 2-4 to emit their respective regular lights to thereby irradiate the object with the respective regular lights, and also causes the CCD 24 to acquire an image of the object. Then, the control passes again to the capture mode. In the pre- and regular emissions, the respective LEDs 2-4 should emit their respective lights with the corresponding driving currents Ir, Ig and Ib determined in the same process as described in the first embodiment. The opening/closing operations of the shutter in the respective processing modes (including the monitor and capture modes) are similar to those performed in the AF control of FIG. 7.

In the above operation, when the respective LEDs 2-4 are caused to emit their respective lights at a place where other light sources such as fluorescent lamps are present, a completely balanced white light cannot be obtained only by balancing the respective lights from the corresponding LEDs 2-4. However, by the pre-emission mentioned above, an excellent balanced white light is ensured. In this case, also in the pre-emission the LEDs 2-4 should ensure respective brightnesses similar to those used in the regular emissions. However, as described with reference to the first embodiment, the power consumption is very small compared to that in the conventional strobes. Therefore, the battery's power consumption is small.

Red-Eye Preventing Operation:

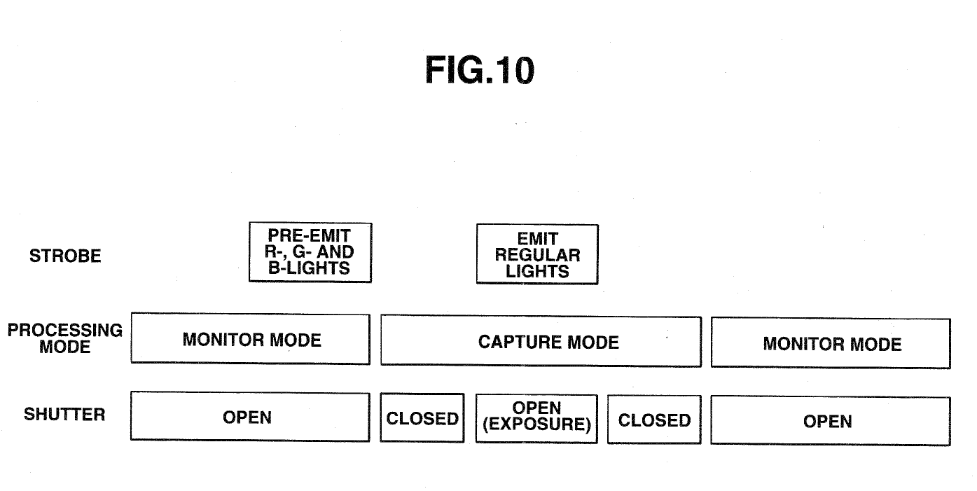

FIG. 10 is a timing chart of operation of the camera 21 for red eye prevention by the MPU 29. As in the prior art, the MPU 29 causes the respective LEDs 2-4 to pre-emit their respective lights to thereby prevent possible occurrence of red eyes in the regular emission of the respective lights from the LEDs 2-4 immediately before the control passes to the capture mode.

Movie Image Pickup:

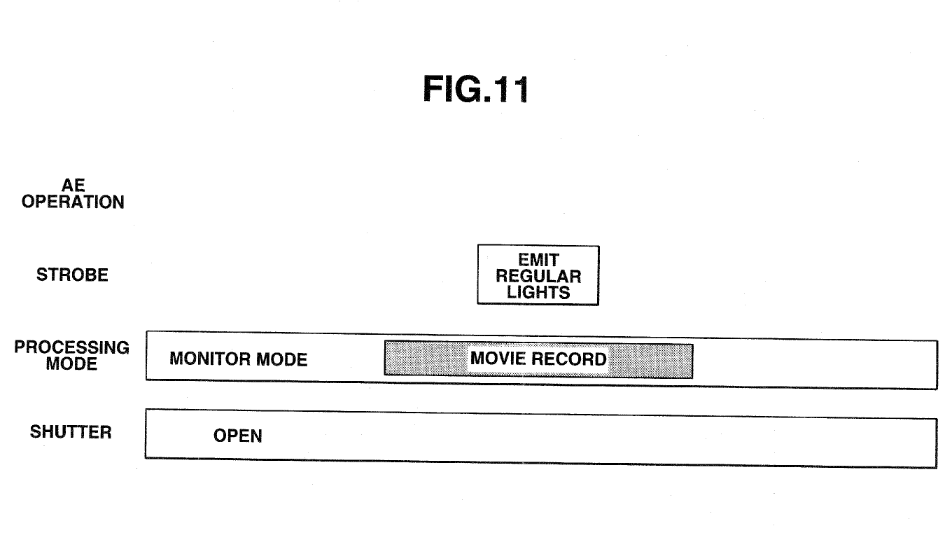

FIG. 11 is a timing chart of operation of the camera 21 for pickup of a movie. In this operation, the monitor mode is set and then a movie record mode is set instead by the user's predetermined manipulation, whereupon the respective LEDs 2-4 are caused to start and continue to emit their respective lights until the movie record mode is terminated.

In the above operation the movie pickup is possible even in a dark place. Even continuation of such movie pickup for a long time influences the battery life slightly. Thus, the range of use of the camera 21 is expended while the battery life is maintained.

Multi-Image Pickup:

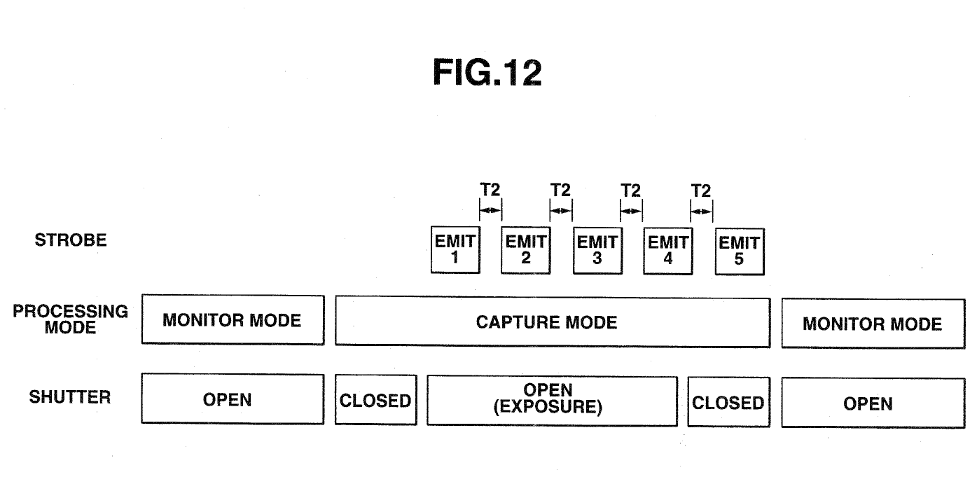

FIG. 12 is a timing chart of operation of the camera 21 for multi-image pickup. In such operation, after the monitor mode is set, control passes to the capture mode in which the CCD 24 acquires the image while the respective LEDs 2-4 are caused to intermittently emit their respective lights, for example, at intervals of time T2 set by the user. This intermittent emission continues until the image has been acquired. The opening/closing operation of the shutter in the respective processing modes (including the monitor and capture modes) is similar to the autofocus control of FIG. 7.

In the above operation, an image of an object indicating its acts can obtained as a multi-image picked up successively. Compared to the conventional strobe using a discharge tube, a quantity of light to be emitted by each of the LEDs 2-4 at a time is similar to the form of a pulse. Therefore, the intervals at which the respective lights are emitted by the LEDs 2-4 can each be set to a short interval to thereby pick up a multi-image of an object indicating more rapid acts.

In addition, the intervals at which the LEDs 2-4 emit their respective lights may be fixed beforehand, and the user may be only required either to set the number of emissions or to set a single emission time period. Alternatively, the user may set a color of a synthetic light to be emitted and control the respective brightnesses of the LEDs 2-4 to obtain that color of the light as described in the second embodiment. In addition, the color of the synthetic light to be emitted may be changed each time it is emitted. In this case, a more effective image is obtained.

Self-Timer Image Pickup:

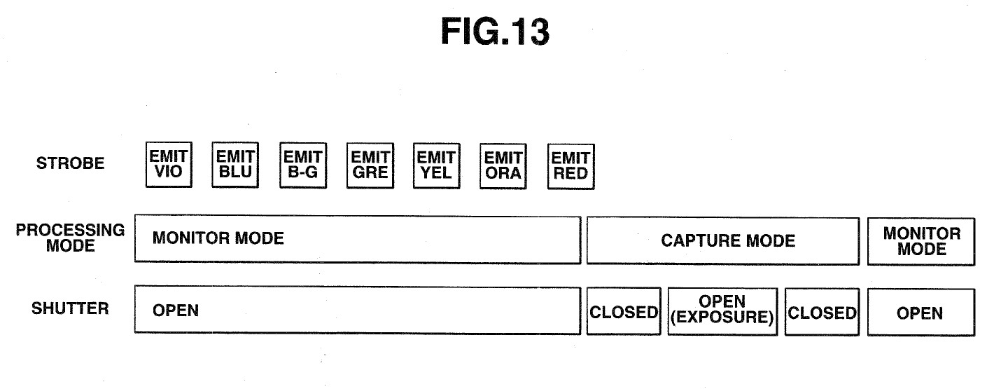

FIG. 13 is a timing chart of operation of the camera 21 for self-timer pickup. In this operation, in the monitor mode after the self timer is set, the respective LEDs 2-4 (strobe) are caused to intermittently emit their respective lights to provide violet (VIO), blue (BLU), blue-green (B-G), green (GRE), yellow (YEL), orange (ORA), and red (RED) lights sequentially in this order as shown. It is to be noted that the opening/closing operation of the shutter in the respective processing modes (including the monitor and capture modes) is similar to that in the auto-focus control of FIG. 7.

In this operation, the quantity of light similar to that required for the regular emission of light is not required. Thus, by suppressing the brightnesses of the respective LEDs 2-4 to lower values, the power consumption is reduced. If the brightnesses of the respective LEDs 2-4 to be set when the environment is dark as at night are lower than those of the LEDs 2-4 that will be set when the environment is not dark, the power consumption is further reduced. The intervals of light emissions of the LEDs 2-4 need not be equal and may be shortened sequentially.

### Fourth Embodiment

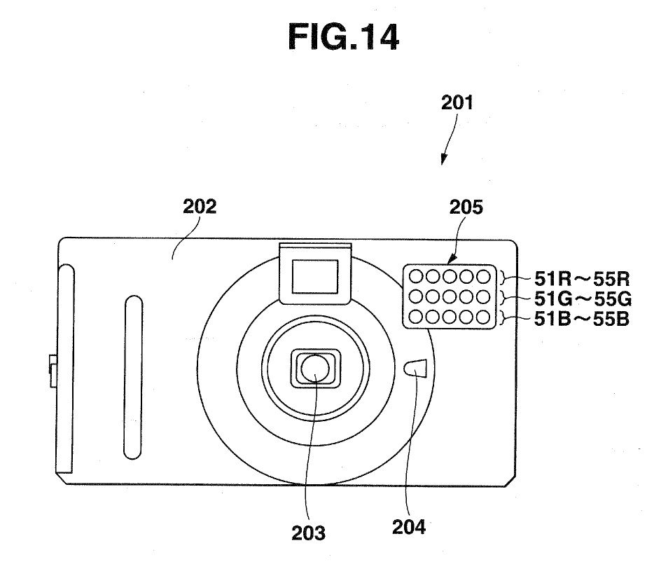

A fourth embodiment of the present invention will be described next. FIGS. 14-16 each show an exterior of an electronic still camera 1 of this embodiment, and are a front view, a plan view and a back view, respectively.

As shown in FIG. 14, the camera 201 comprises a lens 203, an opt-sensor 204, and an array of LEDs 205 on a front of the camera body 202. The LED array 205 is composed of three rows of five LEDs; i.e., a first row of red LEDs 251R-255R each emitting a red light, a second row of green LEDs 51G-55G each emitting a green light, and a third row of blue LEDs 251B-255G each emitting a blue light. These red, green and blue LEDs 251R-255R, 251G-255G and 251B-255B are capable of individually being turned on and off as well as changing their respective quantities of light emissions under control of the MPU 219. Thus, the LED array 205 is capable of being turned on and off at any timing, and emitting light of any color that is changeable in brightness.

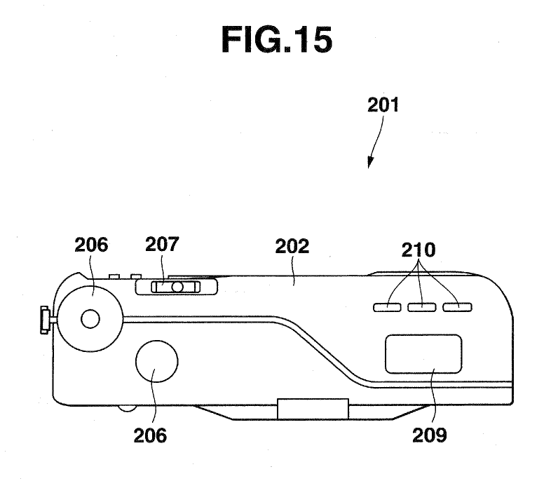

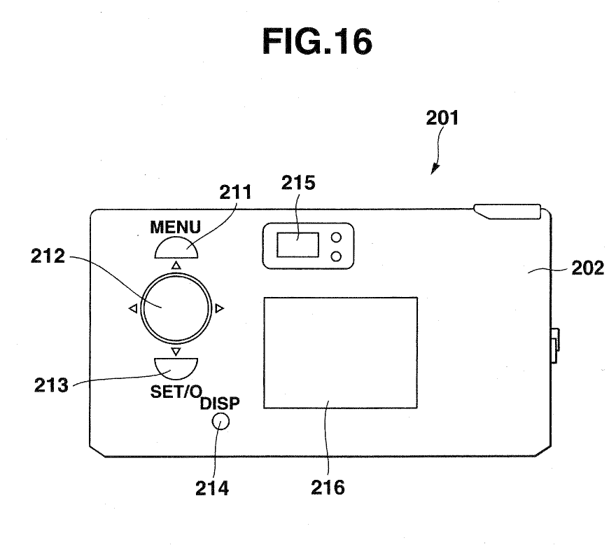

As shown in FIG. 15, an image pickup dial 206, a power supply/function switch 207, a shutter key 208, a control panel 209 and a plurality of keys 210 are provided on top of the camera body 202. The image pickup dial 206 is used to set an image pickup mode such as “character-image pickup mode” or “close-up image pickup mode”. As shown in FIG. 16, a menu key 211, a cursor key 212, a set key 213, a liquid-crystal monitor switch 214, an optical finder 215 and a TFT liquid-crystal monitor 216 are provided on the back of the camera body 202.

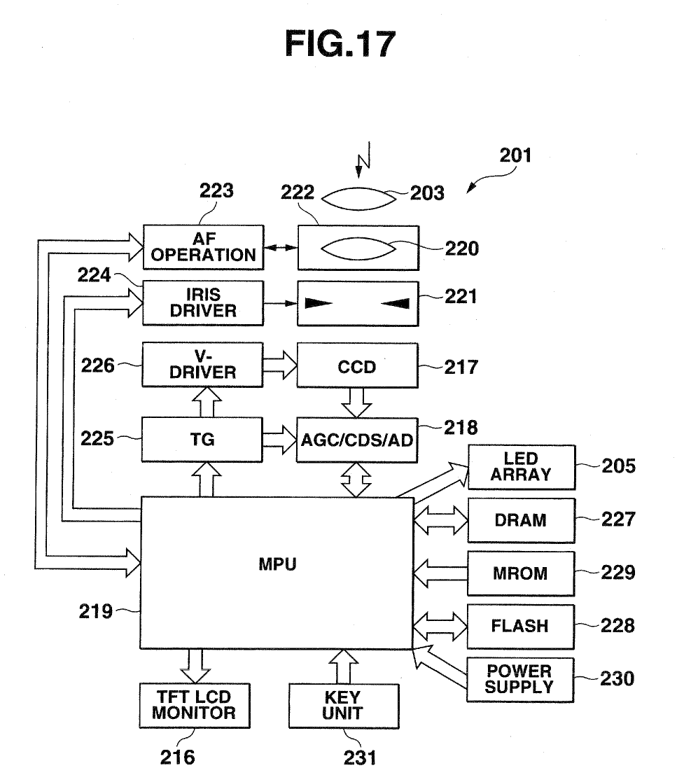

FIG. 17 is a block diagram of an electrical structure of the camera 201. The camera 201 comprises as its core an MPU 219 having an image processing function, for example, of converting an image of an object picked up by a CCD 217 to a JPEG type data. The image of the object that has passed through the lens 203, focus lens 220 and an iris 221 is focused on a light reception surface of the CCD 217. The focus lens 220 is held by a drive mechanism 222 including an AF motor (not shown). When a drive signal outputted from an AF drive 223 is delivered to the driver mechanism 222 by a control signal from the MPU 219, the focus lens 220 moves right and left along the optical axis for focusing purposes. The iris 221 is driven by a drive signal produced by an iris driver 224 based on a control signal from the MPU 219 to thereby adjust a quantity of light entering the CCD 217.

The MPU 219 is connected to a TG (Timing Generator) 225 that generates timing signals. A V (Vertical) driver 226 drives the CCD 217 based on a timing signal generated by the TG 225, which produces an analog image signal representing the object image and which delivers it to a composite circuit 218. The composite circuit 218 comprises a CDS circuit that holds an image signal from the CCD 217, an automatic gain control amplfier AGC that receives the image signal from the CDS, and an A/D converter (AD) that converts the gain-controlled image signal from the AGC to digital image data. The output signal from the CCD 217 is sampled and converted to a digital signal, which is then delivered to the MPU 219 and stored temporarily in a DRAM 227. This signal is then subjected to various processes by the MPU 219, and finally stored as a compressed video signal in a flash memory 228. This stored video signal is read out and expanded by the MPU 219 as required. In addition, a brightness signal and color signals are added to the video signal to produce digital/analog video signals.

The MPU 219 is further connected to a ROM 229, a power supply 230, the key unit 231 of various keys and switches, the TFT liquid-crystal monitor 216 and the LED array 205, as shown in FIGS. 14-16. The ROM 229 is a program ROM that has stored programs for operating the MPU 219 and shown as flowcharts below. The ROM 229 also has stored program AE data that composes a program diagram indicating combinations of iris values F and shutter speeds corresponding to appropriate exposure values EV in image pickup.

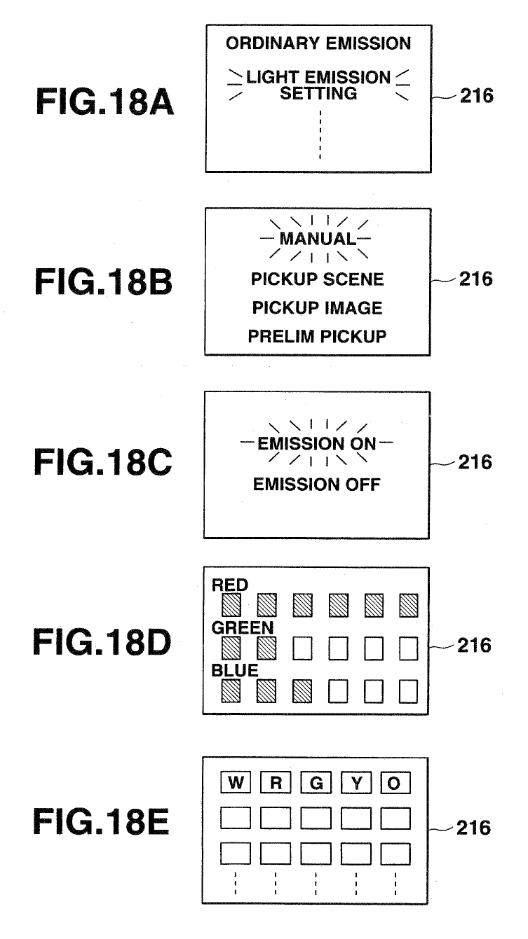

In addition, as shown in FIG. 18E, the ROM 229 has stored color samples such as “white (W)”, “red (R)”, “green (G)”, “yellow (Y)⇄, “orange (O)”, . . . ; and data on the quantities of the respective red, green and blue lights to be emitted by the corresponding LEDs 251R-255R, 251G-255G and 251B-255B in corresponding relationship to produce rays of light of the respective colors represented by the color samples. The ROM 229 has also stored data on the quantities of the respective red, green and blue lights to be emitted by the respective LEDs 251R-255R, 251G-255G and 251B-255B to pickup an image of the object close to the same to advantage when the “close-up image pickup mode” is set by manipulating the image pickup dial 206.

The MPU 219 operates in accordance with the programs, using a built-in RAM as a working memory, to thereby function as setting and control means referred to in the present invention. The MPU 219 also sets a charge storage time of the CCD 217, an opening degree of the iris 221, a gain of the automatic gain control amplifier AGC of the composite circuit 218, etc., in accordance with the program diagram. The charge storage time set by the MPU 219 is delivered as a shutter pulse to the V driver 226 via the TG 225. The V driver 226 operates in response to this shutter pulse to cause the CCD 17 to control the charge storage time or exposure time. That is, the CCD 217 functions as an electronic shutter. The programs stored in the ROM 229 contain a program for autofocus control to cause the MPU 219 to move the focus lens 220 for focusing purposes.

The monitor 216 displays as monitor images the images picked up sequentially in the record mode, and displays videos based on analog video signals produced from image data recorded in the flash memory 228 in a replay mode. The LED array 205 is driven as requested to emit an auxiliary light when the shutter key 208 is pressed (in the image pickup).

The program data, etc., stored in the ROM 229 may be stored in a separate fixed storage device or medium or a removable recording medium such as an IC card as long as its stored data can be maintained. Alternatively, they may be delivered from other devices such as a personal computer.

Operation of the camera 201 in this embodiment will be described next. When the user operates the menu key 211, a menu including items “ordinary light emission” “light emission setting”, . . . of FIG. 18A is displayed on the monitor 216. The “ordinary light emission” is used to cause all the LEDs composing the LED array 205 to emit their respective lights in the image pickup, or to use the LED array 205 as an ordinary flash. The “light emission setting” is used to control the the quantities of red, green and blue lights to be emitted by the LEDs of the LED array 205 to thereby add to the picked-up image a special effect similar to that to be produced when an appropriate filter is used. When the user manipulates the cursor key 212 to move it to the “light emission setting” and then presses a set key 231 on the picture of FIG. 18A, the “light emission setting” is selected. This causes the monitor 216 to display a menu picture of a next light emission mode comprising “manual”, “pickup scene”, “pickup image” and “preliminary pickup” of FIG. 18B.

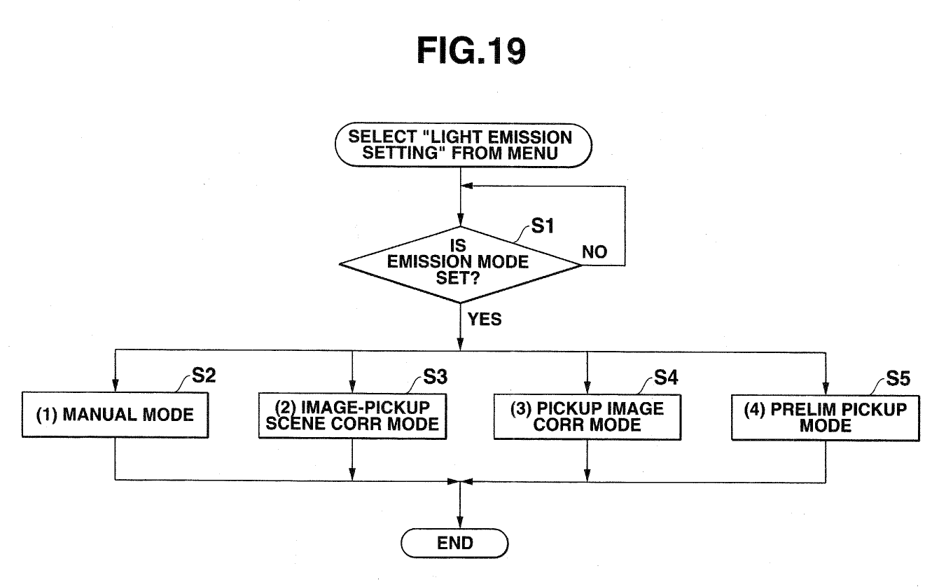

The MPU 219 performs a process indicated by a flowchart of FIG. 19 in accordance with the program stored in the ROM 229 in this state. More particularly, the MPU 219 determines whether or not any one of the “manual”, “pickup scene”, “pickeup image” and “preliminary pickup” is selected or set by the user (step S1). When the “manual” is selected by manipulating the cursor key 212 and the set key 231, the MPU 219 performs a manual mode process (step S2). When the “pickup scene” is selected, the MPU 219 performs a pickup-scene mode process (step S3). When the “pickup image” is selected, the MPU 219 performs a pickup image mode process (step S4). When the “preliminary pickup” is selected, the MPU 219 performs a preliminary pickup mode process (step S5).

(1) Manual Mode Process:

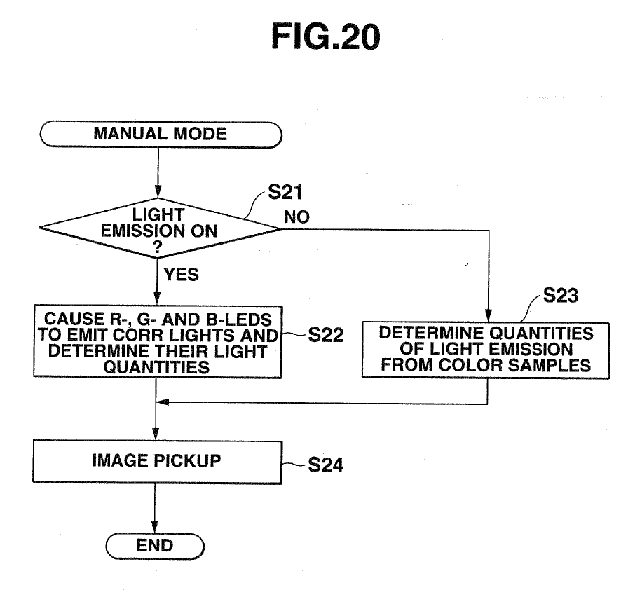

As shown in FIG. 18B, when the “manual” is selected and then the corresponding manual mode process in step S2 is selected, the manual mode process is performed in accordance with a flowchart of FIG. 20. First, a next menu picture including items “light emission on” and “light emission off” is displayed on the monitor 216. The user manipulates the cursor key 212 and the set key 213 in this display state to thereby select the “light emission on” or “light emission off” (step S21).

When “light emission on” is selected, the MPU 219 causes the monitor 216 to display indicators of respective red, green and blue meters, as shown in FIG. 18D. The number of indicators to be turned on in a respective one of the red, green and blue meters, and hence the quantities of red, green and blue lights to be emitted by the corresponding rows of LEDs 251R-255R, 251G-255G and 251B-255B of the LED array 205 are selected. If this selection is satisfactory, those quantities of red, green and blue lights to be emitted by the respective LEDs are then fixed (step S22).

More specifically, as shown in FIG. 18D, when the cursor key 212 is manipulated, for example, at its upper, lower, right and left portions in a state in which the RED, GREEN and BLUE meters are displayed on the monitor 216, the number of indicators of a respecctive one of the red, green and blue meters to be turned on and hence the corresponding quantity of light to be emitted by a respective one of the rows of LEDs 251R-255R, 251G-255G and 251B-255B in which the number of the LEDs of each row to be turned on is selected depending on the selected number of indicators of the corresponding meter are selected to thereby cause the rows of LEDs 251R-255R, 251G-255G and 251B-255B to emit corresponding lights in the respective selected quantities. At this time, the user observes the color of a resulting synthetic light applied actually to the object while viewing the meters. Either any one or any combination of the red, green and blue lights may be emitted. If the user presses the set key 213 when the synthetic light applied has a desired color, the quantities of the red, green and blue lights to be emitted are then fixed in step S22. FIG. 18 illustrates that selection is made so that all six indicators are off in the red meter; two and four indicators are off and on, respectively, in the green meter; and three and three indicators are off and on, respectively, in the blue meter, and hence that the quantities of red, green and blue lights being emitted by the selected corresponding LEDs are selected.

While only the red, green and blue meters of FIG. 18D may be displayed on the monitor 216, these meters may be displayed on the picked-up monitor image in superimposing relationship. As an example, the meter images may be superimposed on the whole picture of the monitor image or, for example like a small sub picture, on the right-end portion of the monitor picture. In this case, the user can recognize the object, to which the required light is applied, even in the monitor picture to thereby facilitate setting of the respective LEDs.

When the shutter key 208 is then pressed, the image pickup process is performed (step 24) in which the red, green and blue LEDs 251R-255R, 251G-255G and 251B-255B are caused to emit their lights in the respective quantities determined in step S22, and then the picked-up image data is stored in the flash memory 228.

When the “light emission on” is not selected in step S21, the quantities of the red, green and blue lights to be emitted are determined in accordance with the color sample menu (step S23). That is, when the “light emission on” is not set, color samples “white (W)”, “red (R)”, “green (G)”, “yellow (Y)”, “orange (O)”, . . . are displayed as shown in FIG. 18E on the monitor 216. In this display state, the user can move the cursor key 12 to a desired sample and then presses the set key 13 to thereby determine a color from the sample menu. Thus, the LED array 5 is not turned on and consumes no power. Thus, if a desired color of light to be emitted is beforehand determined, no “light emission on” is preferably selected.

The relationship between the color samples to be displayed and the quantities of red, green and blue lights to be emitted by the corresponding LEDs 251R-255R, 251G-255G and 251B-255B are stored as data in the ROM 229, as described above. Thus, when the shutter key 208 is pressed after the process in step S23 to thereby perform the image pickup process (step S24), the picked-up image data is stored in the flash memory 228.

Thus, according to the manual mode process, the user can set any quantities of red, green and blue lights to be emitted by the respective LEDs, apply light having a desired color to an object and then pick up its image. Therefore, the user can easily add a desired special effect to an image to be picked up without the need to carry a plurality of filters and to replace a filter attached to the front of the lens with another, as required in the prior art.

(2) Image-Pickup Scene Corresponding Mode Process:

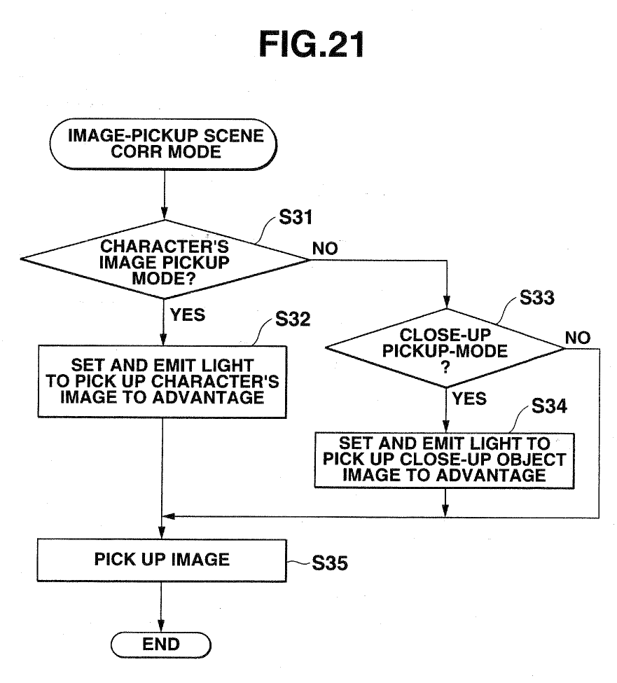

When the pickup-scene corresponding mode (step S3) is selected, a corresponding process is performed in accordance with a flowchart of FIG. 21. First, it is determined whether or not the “character's image pickup mode” is set by the user's manipulation of the image pickup dial 6 (step S31). If the “character's image pickup mode” is set, data on quantities of red, green and blue lights to be emitted by the corresponding LEDs 251R-255R, 251G-255G and 251B-255B to pick up the character's image to advantage are read out from the ROM 229 and set (step S32). When the shutter key 208 is then pressed to thereby perform the image pickup process (step S35), the picked-up image of the object is stored in the flash memory 228.

When the “character's image pickup mode” is not set, it is determined whether the “close-up pickup mode” is set (step S33). If the “close-up pickup mode” is set, data on the quantities of red, green and blue lights to be emitted by the corresponding LEDs 251R-255R, 251G-255G and 251B-255B to pick up an image of the object close to the same to advantage are read out from the ROM 229 and set (step S34). In the “close-up pickup mode”, data on the quantities of red, green and blue lights are set in consideration of possible occurrence of a shadow of the camera 2 due to the camera 2 being placed close to the object. When the shutter key 208 is then pressed, the image pickup process is performed (step S35). The picked-up image of the object is then stored in the flash memory 528.

Thus, according to this pickup-scene corresponding mode process, the red, green and blue LEDs are caused to emit their respective appropriate lights in each of the character image and close-up pickup modes to thereby pick up an image to advantage. Even the user who has no knowledge about a filter effect can easily pick up an image having an atmosphere different from that provided in the ordinary image pickup.

While in the pickup-scene mode corresponding process of this embodiment data on the quantities of red, green and blue lights to be emitted in each of the image pickup modes are read out from the ROM 229 and used to cause the LED array 205 to emit a desired light, the functions to be used in the pickup image mode and to be described in the next paragraph may be combined with those of the present image-pickup scene mode process to sense an image of an object and corresponding quantities of red, green and blue lights to be emitted may be set. Thus, emission of the red, green and blue lights appropriate for the color (fair or dark) of a skin of a character, and such lights allowing for back light is possible in the character-image pickup mode. This applies in the close-up pickup. If the objects are, for example, flowers, they can have various colors. Thus, after an object and then its image are determined, the quantities of red, green and blue lights to be emitted may be set.

(3) Pickup Image Corresponding Mode Process:

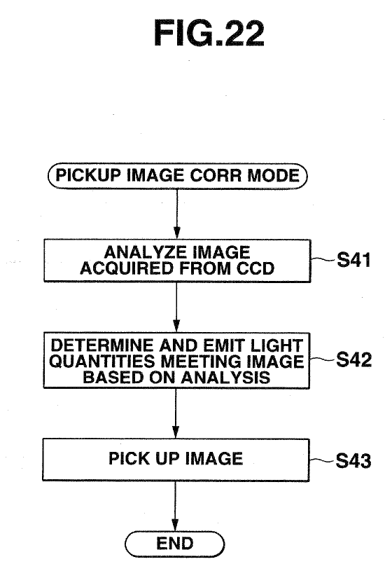

When the pickup image mode (step S4) is selected, this mode process is performed in accordance with a flowchart of FIG. 22. First, an image output from the CCD 217 is analyzed (step S41). The analysis of the image involves determination about a prevailing color of the whole image, for example, about whether or not the image is wholly yellow or blue. As a result, the quantities of red, green and blue lights meeting the image and to be emitted by the LEDs are determined (step S42). When the shutter key 8 is pressed and hence the image pickup process is performed (step S43), the picked-up image is stored in the flash memory 228.

Thus, according to this pickup image corresponding mode, if the object is, for example, a bright-red flower, red, green and blue lights (where the red LEDs 251R-255R are set so as to have high emission intensities) meeting the flower are emitted from the corresponding LEDs. If the scene includes a wholly orangish atmosphere such as will be produced, for example, by a sunset, appropriate quantities of red, green and blue lights are emitted from the corresponding LEDs so as to provide light similar in color to the sunset. Thus, as in the image-pickup scene corresponding mode, the user can easily and unconsciously pick up an image of an object to advantage in any image pickup mode.

(4) Preliminary Image-Pickup Mode Process:

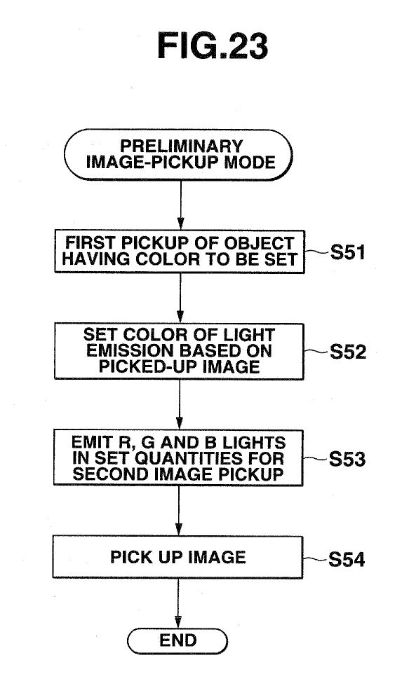

When the preliminary image-pickup mode (step S5) is selected, a corresponding mode process is performed in accordance with a flowchart of FIG. 23. First, an image of an object whose color is to be set is picked up at a first time (step S51). That is, if light having the same color as an object (for example, a wall) should be emitted from the LED array 205, an image of the wall is picked up in a state in which the LED array 205 is off. A color of light to be emitted is set based on the color of the picked-up image (step S52) For example, if the wall is orange, the quantities of red, green and blue lights to be emitted by the corresponding LEDs 251R-255R, 251G-255G and 251B-255B are set so as to cause the LED array 205 to irradiate the object with an appropriate orange light.

Then, when the user presses the shutter key 208 by directing the lens 203 toward the object whose image should be picked up, the red, green and blue LEDs 251R-255R, 251G-255G and 251B-255B emit their respective lights in the respective quantities set in step S52 (step S53). Simultaneously, a second image pickup process is performed (step S54). Then, the picked-up image is stored in the flash memory 228.

Thus, according to this preliminary image-pickup mode, light having a color similar to that of a nearby object such as a wall is emitted. For example, by picking up an image of a fluorescent lamp at a first image-pickup operation in step S51, the LED array 205 can emit light having an identical or similar color to that of light emitted from a fluorescent lamp (step S55). Thus, even in outdoor image pickup, an image expressed as if it were picked up in a room in which a fluorescent lamp is present can he picked up. Emission of an intermediate-colored light difficult to obtain in the set manual mode can be set automatically. That is, setting for emission of light having a fine color can easily be performed.

In any of the respective modes, pickup of a next image after the preceding image has been stored is performed with the same settings as in the preceding case as long as the menu picture of FIGS. 18A and 18B are not changed.

While in the embodiment the LED array is illustrated as composed of three rows of five LEDs; i.e., red LEDs 251R-255R, green LEDs 251G-255G, and blue LEDs 251B-255B arranged linearly in a horizontal direction, the arrangement and number of LEDs composing the LED array are not limited to this particular embodiment. As long as quantities of red, green and blue lights necessary for image pickup are obtained, the LED array may take a different arrangement and comprise a different number of elements of LEDs. The red, green and blue LEDs need not be the same in number.

What is claimed is:

1. A camera apparatus with a flash device, comprising:
an image pickup device for picking up an image of an object;
a storage device for storing as image data an image of the object picked up by the image pickup device;
a light emitting device having a plurality of light emitting diodes disposed on a camera body for emitting a like number of different-colored lights, and for irradiating the object with the like number of different-colored lights;
a driver for supplying power to a respective one of the plurality of light emitting diodes;
a setting device for setting a quantity of light to be emitted by at least one of the plurality of light emitting diodes; and
a controller for controlling the driver such that the at least one of the plurality of light emitting diodes emits a corresponding light in the set quantity of light set by the setting device when the image of the object is picked up.

2. The camera apparatus according to claim 1, wherein:
the camera apparatus has a plurality of image pickup modes; and
the setting device sets a quantity of light to be emitted by a respective one of the plurality of light emitting diodes in accordance with a selected one of the plurality of image pickup modes.

3. The camera apparatus according to claim 1, wherein:
the setting device comprises means for analyzing components of the image of the object picked up by the image pickup device, and sets respective percentages of quantities of lights to be emitted by the plurality of light emitting diodes based on a result of the analysis.

4. The camera apparatus according to claim 1, wherein:
the setting device sets respective percentages of quantities of different-colored lights to be emitted by the plurality of light emitting diodes for emitting a synthetic light having the same color as the image of the object picked up by the image pickup device, based on the color of the picked-up image.

5. The camera apparatus according to claim 4, wherein:
data on a quantity of light to be emitted by a respective one of the plurality of light emitting diodes each for emitting a different-colored light is set in the setting device.

6. The camera apparatus according to claim 1, further comprising:
an input device for inputting to and setting in the setting device data on a quantity of light to be emitted by a respective one of the plurality of light emitting diodes.

7. The camera apparatus according to claim 1, wherein:
the controller controls the driver so that the plurality of light emitting diodes emit different-colored lights in the quantities whose data are set in the setting device by the input device.

8. The camera apparatus according to claim 6, further comprising:
a display device for displaying a plurality of sample colors each for indicating a color of light to be emitted by a respective one of the plurality of light emitting diodes to thereby aid a user in setting a quantity of the light to be emitted.

9. A method of controlling a camera apparatus with a plurality of light emitting diodes disposed on a camera body, each light emitting diode emitting a different-colored light, the method comprising:
picking up an image of an object for confirming purposes, using an image pickup device;
setting data on a quantity of light to be emitted by at least one of the plurality of light emitting diodes, based on the image of the object picked up by the image pickup device;
controlling a quantity of light to be emitted by the at least one of the plurality of light emitting diodes in the image pickup in accordance with the set data on the quantity of light in synchronism with the image of the object for recording purposes being picked up by the image pickup device in response to a shutter button being operated; and
recording in a recording device data on the image picked up by the image pickup device in response to the shutter button being operated.

10. The method according to claim 9, wherein:
data is set on a quantity of light to be emitted by a respective one of the plurality of light emitting diodes each emitting a different-colored light based on the image of the object picked up by the image pickup device.
